(19) United States
(12) Patent Application Publication
(10) Pub. No.: US 2015/0095961 A1
(43) Pub. Date: Apr. 2, 2015

(54) MOCA REMOTE MONITORING AND MANAGEMENT SYSTEM

(71) Applicant: BROADCOM CORPORATION, Irvine, CA (US)

(72) Inventors: Avraham KLIGER, Ramat-Gan (IL); Rami Segal, Hod Hasharon (IL)

(21) Appl. No.: 14/500,922

(22) Filed: Sep. 29, 2014

Related U.S. Application Data
(60) Provisional application No. 61/883,926, filed on Sep. 27, 2013.

(51) Int. Cl. H04N 21/647; H04N 21/24; H04W 8/08; H04L 12/24; H04L 12/26

(52) U.S. Cl. CPC H04N 21/64738; H04L 41/14; H04L 43/08; H04W 8/08; H04N 21/6473; H04N 21/2404
USPC 725/107

(57) ABSTRACT

A system for multimedia over coax alliance (MoCA) remote monitoring and management includes a gateway and multiple local nodes. The gateway communicates with a service provider. The local nodes perform local diagnostics and communicate diagnostic results to the gateway. The gateway and the local nodes form a MoCA remote entity (MoRE) system. The gateway receives and aggregates diagnostic results of the MORE system and facilitates access to aggregated diagnostic results for the service provider.

### CROSS-REFERENCE TO RELATED APPLICATIONS

This application claims the benefit of priority under 35 U.S.C. §119 from U.S. Provisional Patent Application 61/883,926 filed Sep. 27, 2013, which is incorporated herein by reference in its entirety.

### TECHNICAL FIELD

The present description relates generally to communications, and more particularly, but not exclusively, to a multimedia over coax alliance (MoCA) remote monitoring and management system.

### BACKGROUND

Multimedia over coax alliance (MoCA) provides the backbone for the home digital entertainment network, and is supported by MoCA standard organization. MoCA solution supports streaming media such as standard television (SDTV) and high-definition TV (MTV) and allows linking a set-top box (STB) to a TV and a number of entertainment devices in multiple rooms using existing wiring. MoCA coexists with cable TV (CATV) and terrestrial services, provides a clean dedicated medium, and supports content protection. In addition MoCA provides a layer 2 communication protocol that may be used for management and monitoring. This layer 2 protocol is called MoCA Level 2 Management Entity (L2ME), and is an integral part of MoCA protocol. Another layer-2 protocol that can be used for management and monitoring of MoCA Nodes is the IEEE 1905 standard. The IEEE 1905 standard supports communication between Wi-Fi, Home-Plug AV (HP-AV) for power-line communications, and MoCA devices.

### BRIEF DESCRIPTION OF THE DRAWINGS

Certain features of the subject technology are set forth in the appended claims. However, for purpose of explanation, several embodiments of the subject technology are set forth in the Wowing figures.

FIG. 1 is a block diagram illustrating an example of a network environment for remote monitoring and management of multimedia over coax alliance (MoCA) remote entity (MoRE) systems in accordance with one or more implementations.

FIGS. 2A-2B are block diagrams illustrating an example of a MoRE system and a home network in accordance with one or more implementations.

FIGS. 3A-3B are block diagrams illustrating examples of high-level implementations of a local node and a gateway of a MoRE system in accordance with one or more implementations.

FIG. 4 is a table illustrating examples of problems and methods of identification and mitigation of the problems in a MoRE system in accordance with one or more implementations.

FIG. 5 is s flow diagram illustrating an example of a method for remote monitoring and management of a MoRE system in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and can be practiced using one more implementations. In one or more instances, well-known structures and components are shown in block diagram form in order to avoid obscuring the concepts of the subject technology.

According to some implementation of the subject technology, methods and implementations for multimedia over coax alliance (MoCA) remote monitoring and management are described. The disclosed technology provides service providers (e.g., multi-system operators (MSOs)) capabilities to remotely monitor performance and behavior of a number of remote home networks (e.g., home or enterprise networks) at different locations. Current MoCA implementations allow management-information base (MIB) parameters for remote control, which require remote access to each monitored MoCA node via higher layers protocols (e.g., protocols above the Internet protocol (IP) such as simple network management protocol (SNMP) and technical report 69 (TR69) protocol). These higher level protocols are more complex compared to Layer-2 protocols used by MoCA. It is desirable to have MoCA supervising capacities to facilitate for service providers to characterize the remote home network capabilities, address multifunctional issues, and correct them remotely. The subject technology enables the aforementioned with local (e.g., per node) and gateway indications of the quality of the network. The managed network is capable of automatically monitoring itself with green/orange/red status codes that enable remote monitoring and management. The described technology uses Layer-2 protocols, which are much simpler than the commonly used higher layer management protocols, enabling a simple and low-cost solution, for the highly cost sensitive home network devices.

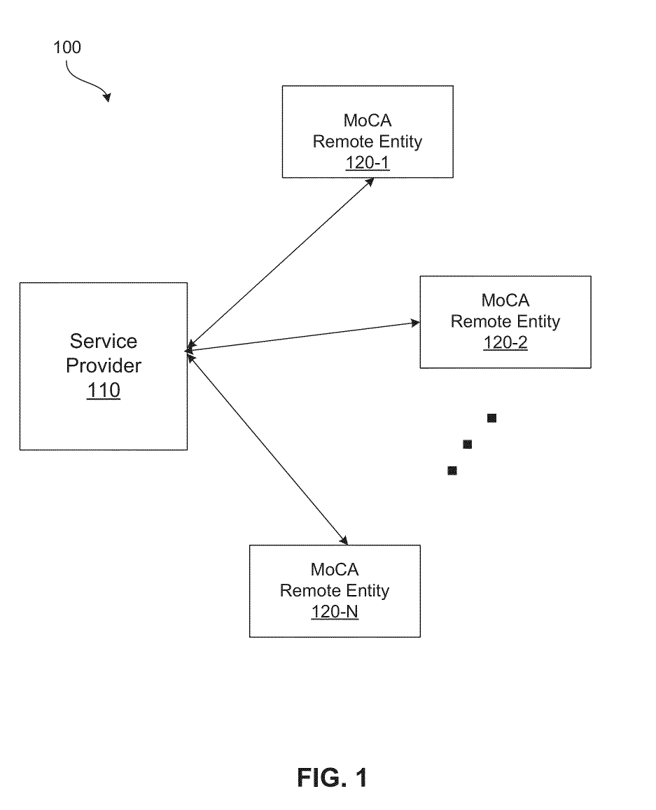

FIG. 1 is a block diagram illustrating an example of a network environment 100 for remote monitoring and management of MoCA remote entity networks in accordance with one or more implementations of the subject technology. The network environment 100 includes a service provider 110 and a number (e.g., N) MoCA remote entities 120 (e.g., 120-1, 120-2 . . . 120-N). Examples of the service provider include an MSO, a cable company, a DSL service provider, a fiber optics service provider, or other service providers. In some aspects, the service provider 110 is coupled to the MoCA remote entities 120 via a network such as the Internet.

In one or more implementations, the MoCA remote entities 120 provide the service provider 110 with a number of supervisory capabilities. Examples of such supervisory capabilities include characterization of the MoCA remote entities 120, access to statistics of failures and performance variation statistics, and prevention of failures before escalation. The failure prevention may be achieved by identifying problematic home networks and providing remote mitigation before a user complains. In one or more aspects, the service provider 110 responds to user calls by remotely monitoring, debugging, and fixing issues, and takes steps to prevent failures before escalation by identifying problematic home networks (e.g., having stationary and non-stationary noise higher than expected, bad connections, bad wiring like old cables, splitters and connectors) and providing remote mitigation.

In some implementations, the supervisory capabilities of the service provider 110 facilitated by the MoCA remote entities 120 enable the service provider 110 to use the information obtained from the MoCA remote entities 120 to identify a number of issues with the home networks. For example, the service provider 110 may be enabled to identify problems such as physical issues with the cable (e.g., identified by disconnection of links and/or receive power instability), narrow in-band external noise, in-band wide stationary noise, and strong non-stationary in-band and out-of-band (OOB) noise, or bad or old splitters with too low isolation or return loss. The information can help the service provider 110 to take various steps to mitigate these issues, for example, perform a number of remote actions, call a customer to fix a problem such as to fasten a cable, or send a technician to a customer premise fix a more complex problem. Examples of the remote actions performed by the service provider 110 includes changing operating frequency, and adding signal-to-noise (SNR) margin, as described in more details herein.

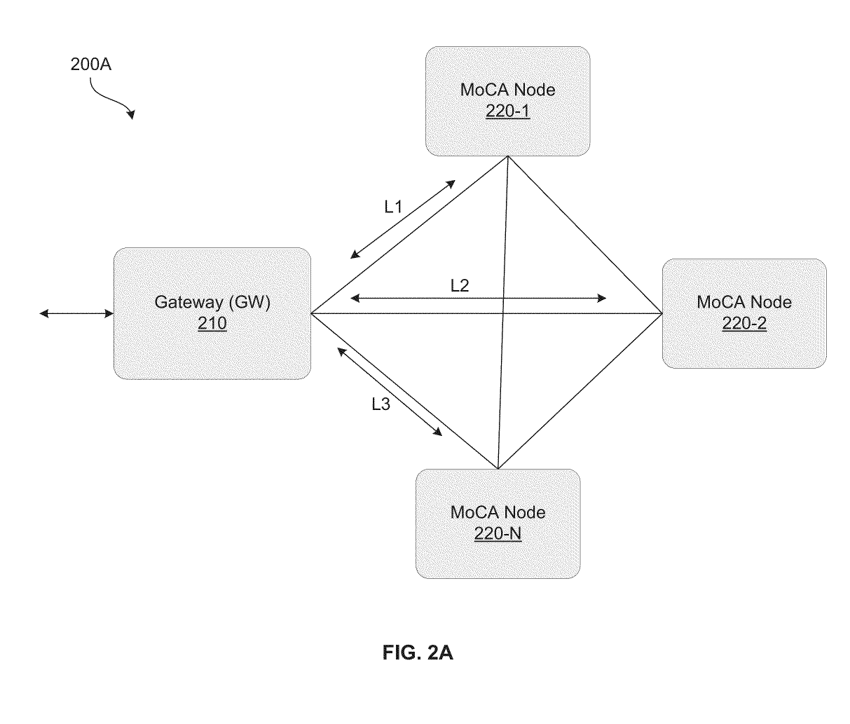

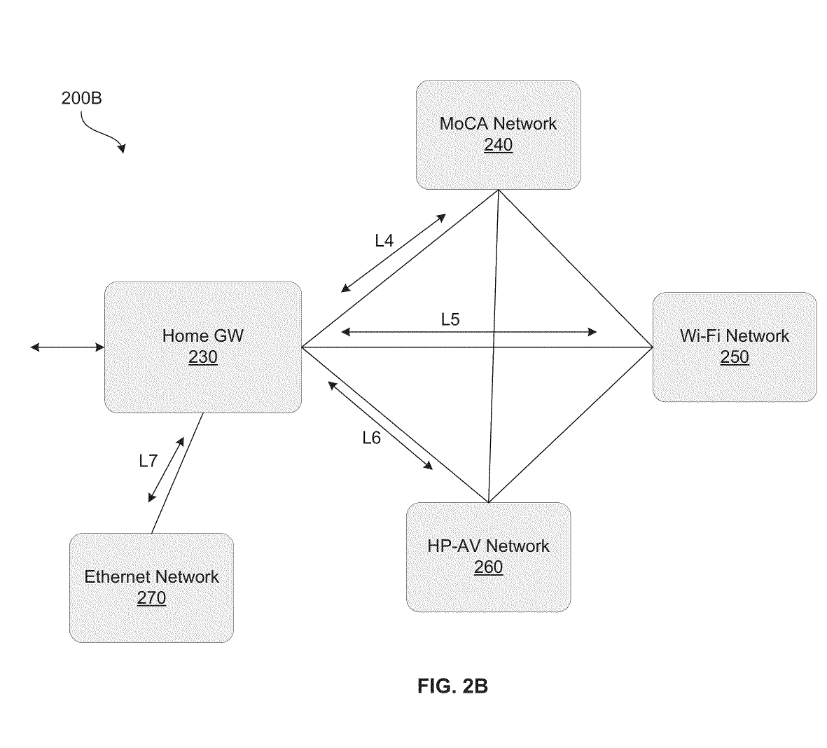

FIGS. 2A-2B are block diagrams illustrating an example of a MoRE system 200A and a home network 200B in accordance with one or more implementations. In one or more implementations, the MoRE system 200A of FIG. 2A includes a gateway (GW) 210 and multiple local nodes 220 (e.g., 220-1, 220-2 . . . 220-N). The gateway 210 can communicate with a service provider (e.g., an MOS such as 110 of FIG. 1). The local nodes 220 perform local diagnostics and communicate diagnostic results to the gateway 210. The gateway 210 receives and aggregates diagnostic results of the MoRE system 200A and facilitates access to aggregated diagnostic results corresponding to the MoRE system for the service provider. In some aspects, the diagnostic results includes status code indicators including red, orange, and green status code indicators corresponding to individual nodes 220. The aggregated diagnostic results are stored in a gateway database, which is accessible by the service provider. The aggregated diagnostic results enable the service provider to identify and mitigate one or more problems experienced by one or more local nodes 220.

The GW 210 can communicate with the service provider using, for example, an Internet protocol (IP) such as SNMP or TR69 protocol. The communication between local nodes 220 and the GW 210 can be performed using a links L1, L2, and L3 (e.g., coax links), which can be operated using MoCA Layer 2 management entity (L2ME) protocol, or the IEEE Std 1905.1 protocol (e.g., IEEE1905.1). The GW 210 is also a part of the MoCA home Network and performs the local nodes features, besides performing the gateway network features.

In some implementations, the home network 200B, as shown in FIG. 2B, includes a home GW 230, a MoCA network 240, a Wi-Fi network 250, a Home-Plug (HP-AV) network 260, and an Ethernet network 270. In some aspects, the home network 200B is not limited to the use by a home and can belong to an enterprise. The communications between the home GW 230 and the MoCA network 240, the Wi-Fi network 250, the Home-Plug (HP-AV) network 260, and the Ethernet network 270 take place using links L4, L5, L6, and L7, which can use the IEEE 1905.1 protocol. The home GW 230 can communicate with a service provider (e.g., an MSO such as 110 of FIG. 1) via SNMP or TR69 protocols. The GW 230 is also a part of the MoCA home Network and performs the local nodes features, besides performing the gateway network features. Each of the MoCA network 240, Wi-Fi network 250, Home-Plug (HP-AV) network 260, and the Ethernet network 270 can perform diagnostics of their corresponding networks and communicate the diagnostic results to the home GW 230. In some aspects, the diagnostics results may include status code indicators including red, orange, and green status code indicators corresponding to the individual networks. The home GW 230 can aggregate the diagnostics results and facilitate access by the service provider to the aggregate the diagnostics results. The aggregated diagnostics results is red when at least one of the networks (e.g., 240, 250, 260 or 27) have been diagnosed with a red status, and is green when all networks are have been diagnosed with a green status. The orange state, however, can be designated to the aggregated diagnostics when a predetermined number (e.g., one or more such as two) of the networks have been diagnosed with an orange status. More detail description of the implementation and function of the local nodes 220 and the GW 210 of FIG. 2A are provided herein. In some implementations, the home GW 230 performs remote monitoring of MoCA nodes of the MoCA network 240, Wi-Fi nodes of the Wi-Fi network 250, or Home-Plug nodes of the HP-AV network 260, via the IEEE 1905 standard protocol.

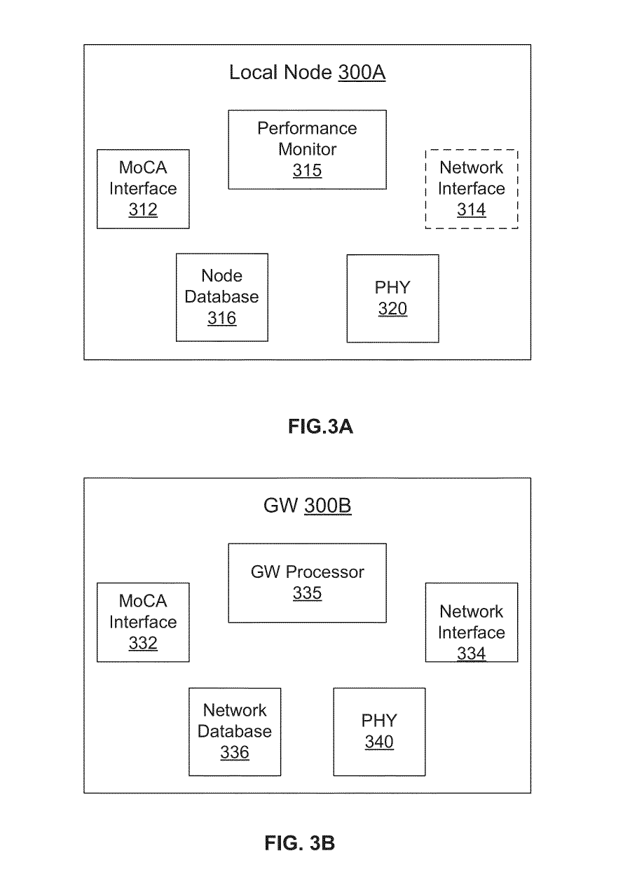

FIGS. 3A-3B are block diagrams illustrating examples of high-level implementations of a local node 300A and a gateway 300B of a MoRE system 200A of FIG. 2A in accordance with one or more implementations of the subject technology. In the high-level implementation shown in FIG. 3A, the local node 300A includes, but is not limited to, a MoCA interface 312, a network interface 314 (optional), a performance monitor 315, a node database 316 and physical layer (PHY) 320. The MoCA interface 312 is used to communicate with the GW 210 of FIG. 2A. The optional network interface 314 can provide communication with a service provider, for example, over the Internet.

The performance monitor 315 can be implemented by a processor and is capable of executing diagnostic algorithms to detect existing issues at the local node 300A and communicate diagnostic results to the GW 210 of FIG. 2A. The diagnostic results include status code indicators including red, orange, and green status code indicators corresponding to the local node 300A, which are stored in the node database 316. The green status is an indication that the local node 300A is in a safe and operational condition, whereas the red status indicates a serious problem such as a disconnection or a non-functional status. The orange status, however, can be an indication that the system is in danger of being unstable or non-functional and needs attention.

In some implementations, the performance monitor 315 can further monitor a number of operational parameters of the local node such as failure indications, SNR, bit loading, receive (RX) power, and channel impulse response, and store corresponding statistics in the node database 316. The performance monitor 315 can, for example, use a re-synch counter, a downtime counter, or various admission-failure counters to monitor failure indications. Quiet probes are periods of time in which no MoCA node is transmitting any signal and allow measuring of the existing noise alone without any signal. In other words, the quiet probes can be used for efficient noise measurements. The bit loading parameter is a measure of the number of bits that the node can load per subcarrier and is therefore an indication of the channel condition such as channel noise and channel attenuation. The performance monitor 315, in addition to statistics on average values of various operational parameters, can further store the last N instances that these parameters have deviated from predetermined values in the node database 316 or from an averaged value. For example, for quiet probe, SNR, bit loading, and RX power parameters, both average and deviating values are stored. In some implementations, the local nodes MoCA MIB parameters and optionally IEEE1905 metrics are also stored in the node database 316.

The PHY 320 is responsible for physically moving data bits across the network interfaces, and performs a number of functions such as encoding, modulating and signaling functions that transform the data from bits into signals that can be sent over the network. The performance monitor 315 measures the data rate associated with the PHY 320 and uses the PHY data rate in a performance measure. For example, the performance monitor 315 may associate the green status to a measured high PHY data rate value and/or high SNR margins, and red status to a measured PHY data rate value and/or low SNR margins. The high and low PHY data rate values depend on the physical conditions of the operating MoCA channel and can vary between different operating channel frequencies. Performance monitor 315 can also measure PHY data rate variation statistics and the corresponding deviations over a time period, on the operating as well as other MoCA channel frequencies, which can be stored in the node database 316 and communicated to the GW 210.

In the high-level implementation shown in FIG. 3B, the GW 300B includes, but is not limited to, a MoCA interface 332, a network interface 334, a GW processor 335, a network database 336, and a PHY 340. The GW 300B is also a part of the MoCA home Network and performs the local nodes features, besides performing the gateway network features. The MoCA interface 332, the network interface 334, and the PHY 340 are respectively similar to the MoCA interface 312, the network interface 314, and the PHY 320 of FIG. 3A. For example, the MoCA interface 332 is used to communicate with the local node 220 of FIG. 2A, and the network interface 334 facilitates communication with a service provider for example, over the Internet. In some implementations, the GW processor 335 can be any processor that is capable of executing network supervisory algorithms to receive and aggregate local node information such as diagnostic results, PHY date rates and variation statistics. The GW processor 335 can perform stationary noise and network performance monitoring, for example, by receiving and aggregating a number of data and statistics including, but not limited to, bit loading, SNR per subcarrier, channel impulse response (CIR), PHY data rate statistics, and RX power and power backoff statistics. It is understood that the SNR per channel can provide more accurate measurement results than bit loading, for example, it can provide margin information. The CIR provides information on channel reflections and can further provide information on suck-outs, bad connections, and bad infrastructure.

The GW processor 335 can further receive and aggregate information such as forward error correction performance statistics, quiet probe statistics, re-synch counter data, downtime statistics, CRC data and/or timeout counter data on control packets, and use at least part of the aggregated information to monitor non-stationary noise of the home network. The quiet probe statistics, for example, can take into account environmental and on-chip generated noise bursts. The quiet probe can enable performing periodic sampling, averaging, and providing short history statistics and noise characterization.

In some implementations, the GW processor 335 can use an alternate channel assessment (ACA) feature of MoCA, which allows assess an alternate frequency channel. The subject technology enables performing periodic ACA (PACA) monitoring of other MoCA frequency channels than the frequency channel at which the MoCA network is operating and obtaining ACA information. In some implementations, PACA can be performed in predetermined periodic intervals (e.g., every few minutes), and is configurable by an operator. The operator, for example, and operator at the service provider can remotely change the operating frequency channel of the MoCA network or change the predetermined periodic intervals that PACA is performed by the GW processor 335. In some aspects, PACA can scan all local nodes and all available in-band frequency channels. The GW processor 335 can store PACA results for each scanned frequency channel as, for example, good, fair, or bad in the network database 336. In some implementations, the GW processor 335 or another module of the GW 300B performs remote monitoring of MoCA nodes and Wi-Fi or Home-Plug nodes (e.g., of FIG. 2B) via the IEEE 1905 standard protocol.

The network database 336 stores various information related to the MoRE system (e.g., 200A of FIG. 2A) that can be used by the GW processor 335 or the service provider. The information stored in the network database 336 include, but are not limited to, local status indicators (e.g., red, green, or orange) of all local nodes in the MoRE system, the full mesh rate (FMR) of the MoRE system, CRC flag indications, which include indicators of packet loss statistics over all nodes, and other retrieved information as described above.

The information stored in the network database 336 is made accessible to the service provider (e.g., 110 of FIG. 1), and the service provider can use the information to take steps to mitigate various issues, as described in more details herein.

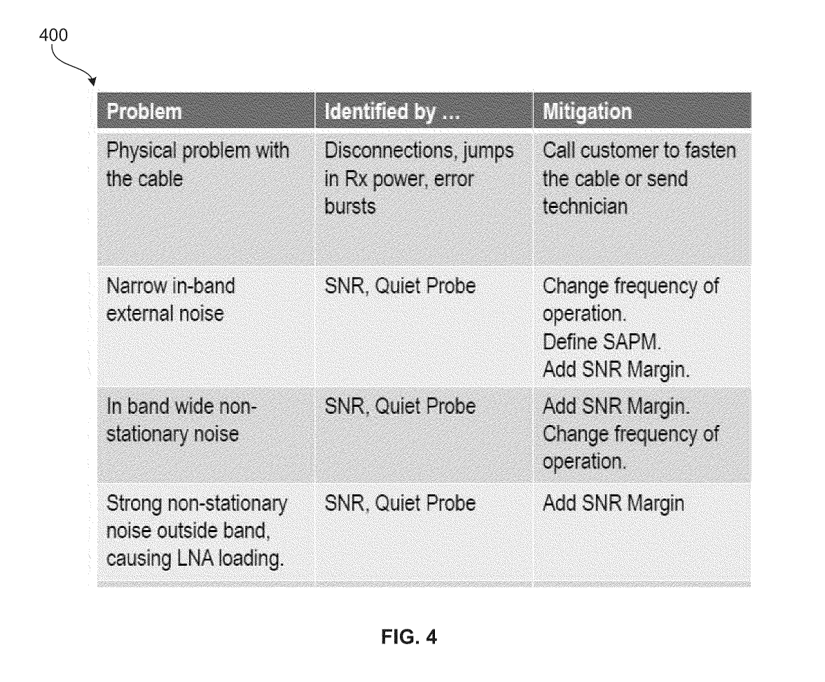

FIG. 4 is a table 400 illustrating examples of problems and methods of identification and mitigation of the problems in a MoCA network in accordance with one or more implementations of the subject technology. Examples of problems encounter in the MoCA network include physical problems with the network, which can be identified by disconnections, jumps in RX power, and error bursts. To mitigate physical problems, the service provider, for example, can call a customer to fix a problem such as to fasten a cable, or send a technician to a customer premise to fix a more complex problem. Sometimes the problem can be caused by a narrow in-band external noise that can be identified by the measured SNR or the quit probe. This problem may be mitigated, for example, by changing frequency channel of operation of the MoCA network, adding SNR margin or defining subcarrier added PHY margin (SAPM) on the operating as well as other MoCA channel frequencies. Other problems in the MoCA network can arise from the presence of in-band wide stationary noise (e.g., white noise such as thermal noise) and strong non-stationary in-band and out-of-band noise that can cause low-noise amplifier (LNA) loading. Both of these problems can be identified by the measured SNR and the quiet probe and can be mitigated by adding SNR margin or changing frequency channel of operation (e.g., for in-band wide stationary noise problem), which can be performed remotely by the service provider.

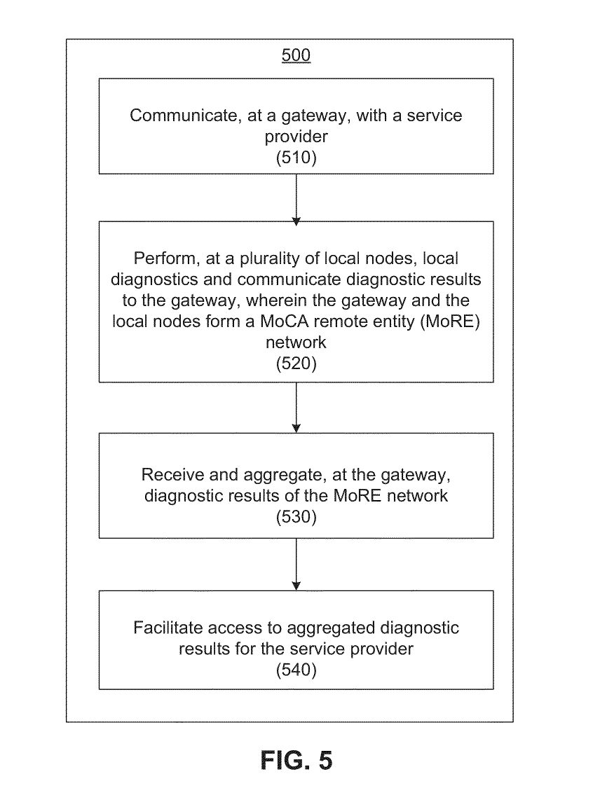

FIG. 5 is s flow diagram illustrating an example of a method 500 for remote monitoring and management of a MoRE system (e.g., 200A of FIG. 2A) in accordance with one or more implementations of the subject technology. For explanatory purposes, the blocks of the example method 500 are described herein as occurring in serial, or linearly. However, multiple blocks of the example method 500 can occur in parallel. In addition, the blocks of the example method 500 need not be performed in the order shown and/or one or more blocks of the example method 500 need not be performed.

The method 500 includes communicating, at a gateway (e.g., 210 of FIG. 2A), with a service provider (e.g., 110 of FIG. 1) (510). Local diagnostics is performed at a number of local nodes (e.g., 220-1, 220-2 . . . 220-N of FIG. 2A), and diagnostic results are communicated to the gateway (520). The gateway and the local nodes form a MoCA remote entity (MoRE) network (e.g., 200A of FIG. 2A). At the gateway, diagnostic results of the MoRE system are received and aggregated (530). Access to aggregated diagnostic results is facilitated for the service provider (540). The Gateway is also a part of the MoCA home Network and performs the local nodes features, besides performing the gateway network features.

Those of skill the art would appreciate that the various illustrative blocks, modules, elements, components, and methods described herein can be implemented as electronic hardware, computer software, or combinations of both. To illustrate this interchangeability of hardware and software, various illustrative blocks, modules, elements, components, and methods have been described above generally in terms of their functionality. Whether such functionality is implemented as hardware or software depends upon the particular application and design constraints imposed on the overall system. Skilled artisans can implement the described functionality in varying ways for each particular application. Various components and blocks can be arranged differently (e.g., arranged in a different order, or partitioned in a different way) all without departing from the scope of the subject technology.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as “an aspect” does not imply that such aspect is essential to the subject technology or that such aspect applies to all configurations of the subject technology. A disclosure relating to an aspect can apply to all configurations, or one or more configurations. An aspect can provide one or more examples of the disclosure. A phrase such as an “aspect” refers to one or more aspects and vice versa. A phrase such as an “embodiment” does not imply that such embodiment is essential to the subject technology or that such embodiment applies to all configurations of the subject technology. A disclosure relating to an embodiment can apply to all embodiments, or one or more embodiments. An embodiment can provide one or more examples of the disclosure. A phrase such an “embodiment” can refer to one or more embodiments and vice versa A phrase such as a “configuration” does not imply that such configuration is essential to the subject technology or that such configuration applies to all configurations of the subject technology. A disclosure relating to a configuration can apply to all configurations, or one or more configurations. A configuration can provide one or more examples of the disclosure. A phrase such as a “configuration” can refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system for multimedia over coax alliance (MoCA) remote monitoring and management, the system comprising:
a gateway configured to communicate with a service provider; and
a plurality of local nodes configured to perform local diagnostics and to communicate diagnostic results to the gateway, wherein the gateway and the plurality of local nodes form a MoCA remote monitoring and management entity (MoRE) system, and wherein the gateway is further configured to receive and aggregate diagnostic results of the MoRE system and facilitate access to aggregated diagnostic results for the service provider.

2. The system of claim 1, wherein the diagnostic results comprise status code indicators including red, orange, and green status code indicators corresponding to individual nodes of the plurality of local nodes, and wherein the aggregated diagnostic results correspond to the MORE system, and wherein the gateway is further configured to perform local diagnostics as being a node of the MoRE system.

3. The system of claim 1, wherein the aggregated diagnostic results are stored in a gateway database, wherein the gateway database is accessible to the service provider, and wherein the data stored in the gateway database comprise at least local status code indicators corresponding to the plurality of local nodes and network indicators including full mesh rate (FMR) of the MoRE system and CRC flag indications.

4. The system of claim 1, wherein the aggregated diagnostic results enables the service provider to identify and to mitigate, using mitigation measures, one or more problems experienced by one or more nodes of the plurality of local nodes.

5. The system of claim 4, wherein the one or more problems comprise one or more physical problems, narrow in-band external noise, in-band wide stationary and non-stationary noise, and strong stationary and non-stationary outside-band noise, and wherein the mitigation measures comprise changing operation frequency, and adding signal-to-noise (SNR) margin.

6. The system of claim 1, wherein performing local diagnostics comprises performing periodic alternate channel assessment (PACA), and wherein the MoRE system is configured to mitigate some of the problems experienced by one or more nodes of the plurality of local nodes using the diagnostic results.

7. The system of claim 1, wherein the local nodes comprise MoCA nodes and MoRE system internal communications are performed using a MoCA layer 2 management entity (L2ME) protocol or an IEEE 1905 layer-2 protocol, wherein the local nodes further comprises Home-Plug nodes or Ethernet nodes and the MORE system internal communications are performed using an IEEE 1905 protocol.

8. The system of claim 1, wherein the MoRE system further facilitates for the service provider to perform PHY characterization of the MoCA networks, to obtain statistics of failure and performance statistics of remote MoCA entities, and to prevent failures before escalation by identifying problematic remote home networks and providing remote mitigations before a user complains.

9. The system of claim 1, wherein each node of the plurality of nodes includes a node database that stores node data, wherein the node data comprises node MoCA management information base (MIB) parameters, IEEE 1905 parameters, failure indications, quiet probe statistics, signal-to-noise (SNR) and bit-loading statistics, receive (RX) power statistics, channel impulse response statistics, and status code indicators.

10. A method for remote monitoring and management of multimedia over coax alliance (MoCA), the method comprising:
communicating, at a gateway, with a service provider;
performing, at a plurality of local nodes, local diagnostics and communicating diagnostic results to the gateway, wherein the gateway and the plurality of local nodes form a MoCA remote entity (MoRE) system;
receiving and aggregating, at the gateway, diagnostic results of the MoRE system; and
facilitating access to aggregated diagnostic results for the service provider.

11. The method of claim 10, wherein receiving and aggregating the diagnostic results comprise receiving and aggregating status code indicators including red, orange, and green status code indicators corresponding to individual nodes of the plurality of local nodes, and wherein the aggregated diagnostic results correspond to the MoRE system.

12. The method of claim 10, further comprising:
storing the aggregated diagnostic results in a gateway database,
making the gateway database accessible to the service provider, and
storing other data in the gateway database, wherein the other data comprise local status code indicators corresponding to the plurality of local nodes and network indicators including full mesh rate (FMR) of the MoRE system and CRC flag indications.

13. The method of claim 10, further comprising, using the aggregated diagnostic results, enabling the service provider to identify and to mitigate, using mitigation measures, one or more problems experienced by one or more nodes of the plurality of local nodes.

14. The method of claim 13, wherein the one or more problems comprises one or more physical problems, narrow in-band external noise, in-band wide stationary or non-stationary noise, and strong stationary or non-stationary out-of-band noise, and wherein the mitigation measures comprise changing operation frequency, and adding signal-to-noise (SNR) margin.

15. The method of claim 10, wherein performing local diagnostics comprises performing periodic alternate channel assessment (PACA), and the method further comprises configuring the MoRE system to mitigate some of the problems experienced by one or more nodes of the plurality of local nodes using the diagnostic results.

16. The method of claim 10, wherein the local nodes comprise MoCA nodes and the method further comprises performing MoRE system internal communications using a MoCA layer 2 management entity (L2ME) protocol or an IEEE 1905 layer-2 protocol, and wherein the local nodes further comprises Wi-Fi, Home-Plug nodes, or Ethernet nodes and the method further comprises performing MoRE system internal communications using an IEEE 1905 protocol.

17. The method of claim 10, further comprising facilitating for the service provider to:
perform PHY characterization of the MoCA networks,
obtain statistics of failure and performance statistics of remote MoCA entities, and
prevent failures before escalation by identifying problematic remote home networks and providing remote mitigations before a user complains.

18. The method of claim 10, wherein each node of the plurality of nodes includes a node database and the method further comprises storing node data in the node database, wherein the node data comprises node MoCA management information base (MIB) parameters, IEEE 1905 parameters, failure indications, quiet probe statistics, signal-to-noise (SNR) and bit-loading statistics, receive (RX) power statistics, channel impulse response statistics, and status code indicators.

19. A gateway comprising:
a first network interface configured to communicate with a plurality of local nodes of a MoCA remote monitoring and management entity (MoRE) system and to receive diagnostic results of local diagnostics perfumed by the plurality of local nodes of the MoRE system;
a processor configured to aggregate the diagnostic results and provide aggregated diagnostic results; and
a second network interface configured to communicate with a service provider and to facilitate remote monitoring and management of the MoRE system for the service provider by providing access by the service provider to the aggregated diagnostic.

20. The gateway of claim 19, further comprising a network database configured to store network-level raw information and the aggregated diagnostic results, wherein data stored in the network database comprise local status code indicators corresponding to the plurality of local nodes and full mesh rate (FMR) of a MoCA network and CRC flag indications, and wherein the processor is further configured to perform remote monitoring of MoCA nodes and Wi-Fi or Home-Plug nodes via an IEEE 1905 standard protocol.
